(19) United States
(12) Patent Application Publication
(10) Pub. No.: US 2018/0276568 A1
(43) Pub. Date: Sep. 27, 2018

(54) MACHINE LEARNING METHOD AND MACHINE LEARNING APPARATUS

(71) Applicant: FUJITSU LIMITED, Kawasaki-shi (JP)

(72) Inventor: Naoki Takahashi, Kawasaki (JP)

(73) Assignee: FUJITSU LIMITED, Kawasaki-shi (JP)

(21) Appl. No.: 15/913,408

(22) Filed: Mar. 6, 2018

(30) Foreign Application Priority Data
Mar. 27, 2017 (JP) 2017-061412

(51) Int. Cl. G06N 99/00; G06F 17/30

(52) U.S. Cl. CPC G06N 99/005; G06F 17/30011

(57) ABSTRACT

A machine learning method includes acquiring teacher data to be used in supervised learning, and plurality of document data, specifying first document data among the plurality of document data in accordance with a first feature value and a second feature value, the first feature value being decided in accordance with a frequency of appearance of a word in the teacher data, the second feature value being decided in accordance with a frequency of appearance of the word in each of the plurality of document data, and performing machine-learning of characteristic information of the first document data as pre-learning for the supervised learning.

### CROSS-REFERENCE TO RELATED APPLICATION

This application is based upon and claims the benefit of priority of the prior Japanese Patent Application No. 2017-61412, filed on Mar. 27, 2017, the entire contents of which are incorporated herein by reference.

### FIELD

The embodiment discussed herein is related to a machine learning technique.

### BACKGROUND

Recently, machine learning has been used to construct a database used for retrieval and so on. In machine learning, unsupervised learning of learning inputs as pre-learning may be performed before supervised learning of learning of inputs and respective outputs. In unsupervised learning, as the quantity of data increases, the learning result is improved. For this reason, various types of data such as news on the Internet, technical information, and various manuals has been often used as inputs to unsupervised learning. A related art is disclosed in Japanese Laid-open Patent Publication No. 2004-355217.

### SUMMARY

According to an aspect of the invention, a machine learning method includes acquiring teacher data to be used in supervised learning, and plurality of document data, specifying first document data among the plurality of document data in accordance with a first feature value and a second feature value, the first feature value being decided in accordance with a frequency of appearance of a word in the teacher data, the second feature value being decided in accordance with a frequency of appearance of the word in each of the plurality of document data, and performing machine-learning of characteristic information of the first document data as pre-learning for the supervised learning.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a learning apparatus in an embodiment;

FIG. 2 illustrates an example of machine learning;

FIG. 3 illustrates an example of a document data storage section;

FIG. 4 illustrates an example of a teacher data storage section;

FIG. 5 illustrates an example of a first feature value storage section;

FIG. 6 illustrates an example of a second feature value storage section;

FIG. 7 illustrates an example of a filter storage section;

FIG. 8 illustrates an example of a pre-learning document data storage section;

FIG. 9 illustrates an example of a result of filtering;

FIG. 10 illustrates an example of filtering based on the frequency of appearance of words;

FIG. 11 is a flow chart illustrating an example of learning processing in accordance with the embodiment;

FIG. 12 is a flow chart illustrating an example of filter generation processing;

FIG. 13 is a flow chart illustrating an example of identification processing; and

FIG. 14 illustrates an example of a computer that runs a learning program.

### DESCRIPTION OF EMBODIMENT

According to the conventional technique, when the field of data used in unsupervised learning as pre-learning is different from the field of data used in supervised learning, a model of machine learning may be adversely affected. For this reason, for example, the database administrator selects the data used in unsupervised learning, such that the field of data matches the field of data used in supervised learning. However, it takes much time and effort to select a large quantity of data. It may lower the efficiency of learning the model of machine learning.

Referring to figures, an embodiment of a learning program, a learning method, and a learning apparatus, which are disclosed in this application, will be described below. It is noted that the disclosed technique is not limited by the embodiment. The below-mentioned embodiment may be combined in any suitable manner.

### Embodiment

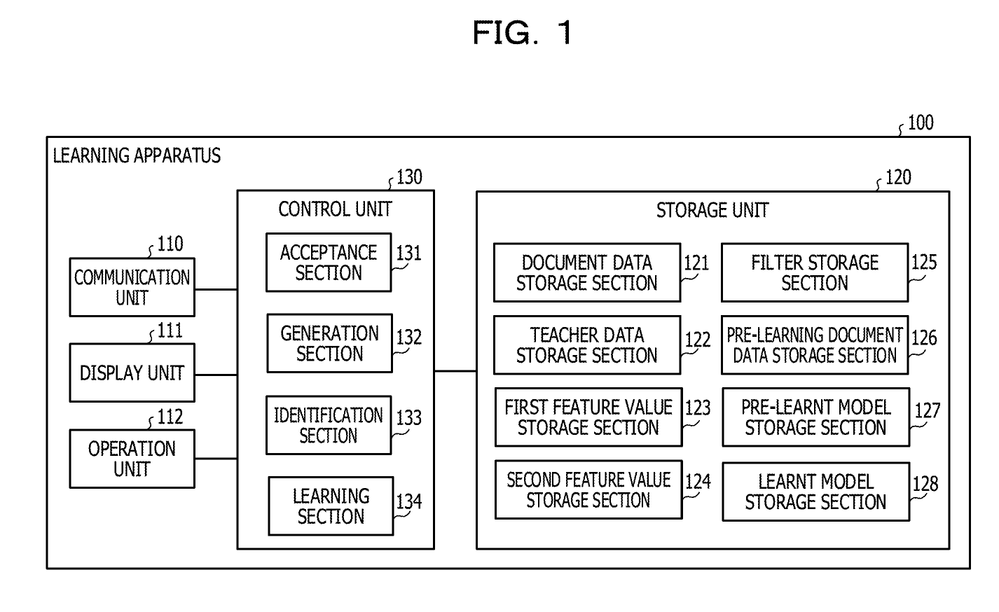

FIG. 1 is a block diagram illustrating an example of a configuration of the learning apparatus in the embodiment. The learning apparatus 100 illustrated in FIG. 1 is an example of an information processor that performs unsupervised learning as the pre-learning and then, performs supervised learning to generate a model of machine learning. Examples of the learning apparatus 100 include a fixed or portable personal computer, and a server. Cloud computing techniques such as Software as a Service (SaaS) and Platform as a Service (PaaS) may be applied to the learning apparatus 100.

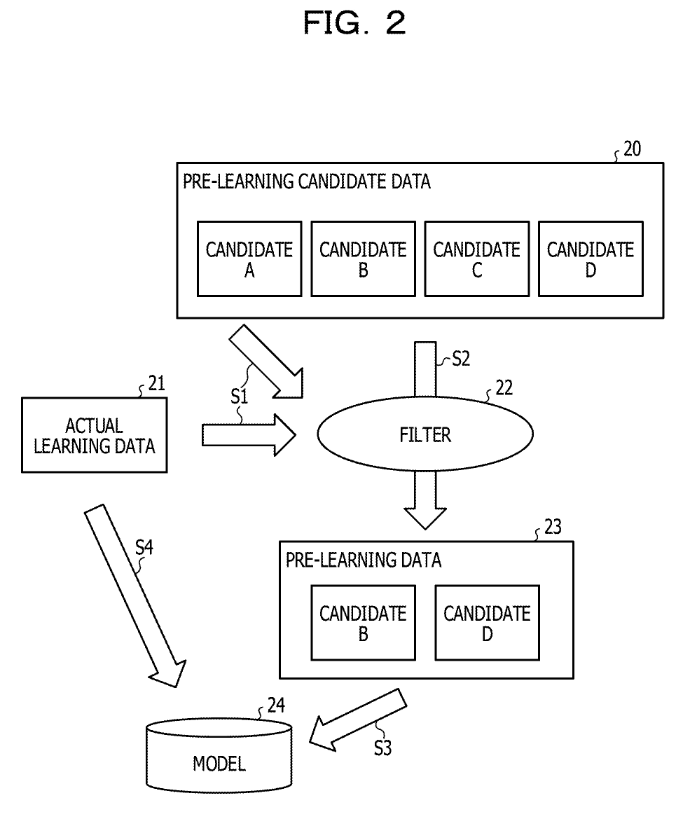

The machine learning in this embodiment will be described with reference to FIG. 2. FIG. 2 illustrates an example of machine learning. Candidate data 20 for pre-learning in FIG. 2 is candidate data for document data used in unsupervised learning. The candidate data includes, for example, four candidates A to D. Actual learning data 21 is an example of teacher data having inputs and outputs that correspond to a model to be generated in machine learning. First, based on the pre-learning candidate data 20 and the actual learning data 21, the learning apparatus 100 generates a filter 22 (Step S1). Next, the learning apparatus 100 applies the filter 22 to the candidates A to D of the pre-learning candidate data 20 (Step S2). The learning apparatus 100 selects the candidates B and D according to the filter 22 as pre-learning data 23. Using the pre-learning data 23, the learning apparatus 100 generates a model 24 (Step S3). At this time, the model 24 becomes a pre-learnt model. Then, when the learning apparatus 100 causes the model 24 to learn the actual learning data 21 (Step S4), the model 24 becomes a learnt model, and may be used for services such as retrieval.

In other words, the learning apparatus 100 performs unsupervised learning prior to supervised learning. That is, the learning apparatus 100 accepts teacher data used in supervised learning, and a plurality of document data each including a plurality of sentences. The learning apparatus 100 identifies any one of plurality of document data, based on the correlation between the accepted teacher data and each of the plurality of document data. The learning apparatus 100 machine-learns feature information on the identified document data. In this manner, the learning apparatus 100 may improve its learning efficiency.

Next, the configuration of the learning apparatus 100 will be described. As illustrated in FIG. 1, the learning apparatus 100 has a communication unit 110, a display unit 111, an operation unit 112, a storage unit 120, and a control unit 130. Noted that the learning apparatus 100 may have various functional units built in well-known computers, other than the functional units in FIG. 1, for example, various input device and audio output devices.

For example, the communication unit 110 is embodied as a network interface card (NIC). The communication unit 110 is a communication interface connected to other information processors in a wired or wireless manner via a network not illustrated, and communicates information with other information processors. The communication unit 110 receives the plurality of document data and the teacher data from other information processors. The communication unit 110 outputs the plurality of received document data and teacher data to the control unit 130.

The display unit 111 is a display device that displays various information. For example, the display unit 111 is embodied as a liquid crystal display. The display unit 111 displays various screens such as display screen inputted from the control unit 130.

The operation unit 112 is an input device that accepts various operations from the administrator of the learning apparatus 100. For example, the operation unit 112 is embodied as a keyboard or a mouse. The operation unit 112 outputs the operation inputted by the administrator as operation information to the control unit 130. The operation unit 112 may be embodied as a touch panel, and the display unit 111 that is the display device may be integrated with the operation unit 112 that is the input device.

For example, the storage unit 120 is embodied as a semiconductor memory element such as a random access memory (RAM) and a flash memory, or a storage device such as hard disc and an optical disc. The storage unit 120 has a document data storage section 121, a teacher data storage section 122, a first feature value storage section 123, and a second feature value storage section 124. The storage unit 120 further has a filter storage section 125, a pre-learning document data storage section 126, a pre-learnt model storage section 127, and a learnt model storage section 128. The storage unit 120 further stores information used for processing in the control unit 130.

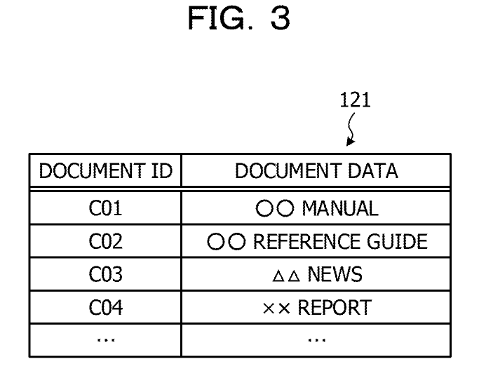

The document data storage section 121 stores candidate document data used in pre-learning. FIG. 3 illustrates an example of the document data storage section. As illustrated in FIG. 3, the document data storage section 121 has items including “document identifier (ID)” and “document data”. For example, the document data storage section 121 stores one record for each document ID.

The “document ID” is an identifier that identifies candidate document data for pre-learning. The “document data” is information indicating the candidate document data for pre-learning. That is, the “document data” is a corpus for unsupervised learning (candidate corpus). In the example illustrated in FIG. 3, for convenience of description, the “document data” is document name. The first line in FIG. 3 indicates that the document data having the document ID of “C01” is a document named “XX Manual”. In summary, the “document data” includes sentences constituting the document, that is, a plurality of sentences.

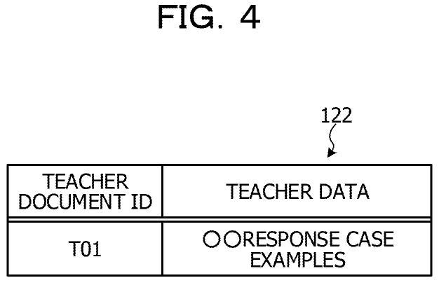

Returning to the description referring to FIG. 1, the teacher data storage section 122 stores the teacher data that is document data used in actual learning, that is, supervised learning. FIG. 4 illustrates an example of the teacher data storage section. As illustrated in FIG. 4, the teacher data storage section 122 has items including “teacher document ID” and “teacher data”. For example, the teacher data storage section 122 stores one record for each teacher document ID.

The “teacher document ID” is an identifier that identifies teacher data for supervised learning. The “teacher data” indicates the teacher data for supervised learning. That is, “teacher data” is an example of a corpus for supervised learning. In the example illustrated in FIG. 4, for convenience of description, “teacher data” is document name.

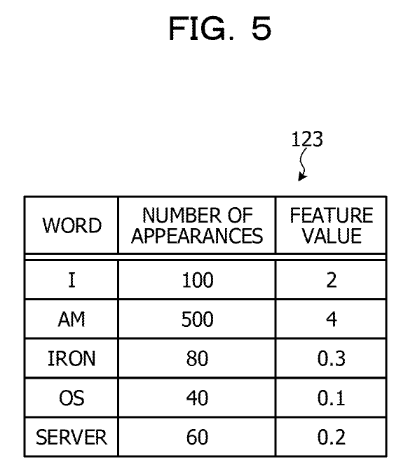

Returning to the description referring to FIG. 1, the first feature value storage section 123 associates the number of appearances with a feature value of each word in all of accepted document data, that is, all of document data for pre-learning, and stores them. FIG. 5 illustrates an example of the first feature value storage section. As illustrated in FIG. 5, the first feature value storage section 123 has items including “word”, “number of appearances”, and “feature value”. For example, the first feature value storage section 123 stores one record for each word.

The “word” is information indicating nouns, verbs, and so on extracted from all of document data for pre-learning by morphological analysis or the like. The “number of appearances” indicates the sum of the number of appearances for each word in all of document data for pre-learning. The “feature value” indicates a first feature value acquired by normalizing the frequency of appearance of each word in all of the document data for pre-learning, based on the number of appearances of the word. In the fifth line in FIG. 5, a word “server” appears 60 times in all of the document data for pre-learning, and its feature value is “0.2”.

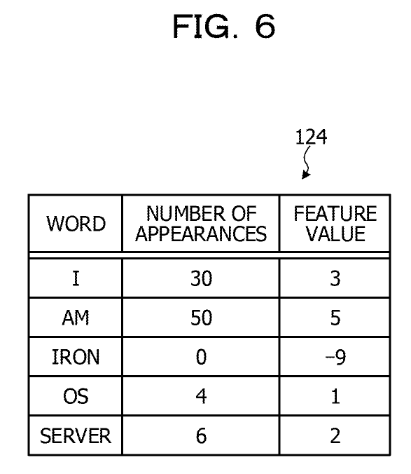

Returning to the description referring to FIG. 1, the second feature value storage section 124 associates the number of appearances with a feature value of each word in the teacher data, and stores them. FIG. 6 illustrates an example of a second feature value storage section. As illustrated in FIG. 6, the second feature value storage section 124 has items including “word”, “number of appearances”, and “feature value”. The second feature value storage section 124 stores one record for each word.

The “word” is information indicating nouns, verbs, and so on extracted from the teacher data by morphological analysis or the like. The “number of appearances” indicates the sum of the number of appearances for each word in the teacher data. The “feature value” indicates a second feature value acquired by normalizing the frequency of appearance of each word in the teacher data. In the fifth line in FIG. 6, a word “server” appears 6 times, and its feature value is “2”.

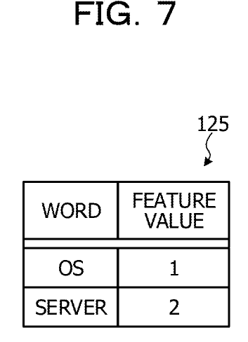

Returning to the description referring to FIG. 1, the filter storage section 125 associates with the word used as a filter with the feature value, and stores them. FIG. 7 illustrates an example of the filter storage section. As illustrated in FIG. 7, the filter storage section 125 has items including “word” and “feature value”. The filter storage section 125 stores one record for each word.

The “word” indicates the word used as the filter among the words stored in the second feature value storage section 124. The “feature value” indicates the second feature value corresponding to the word used as the filter. That is, the filter storage section 125 stores the second feature value corresponding to the word representing the feature of the teacher data, among the second feature values based on the teacher data, along with the word. In the example illustrated in FIG. 7, the feature value “1” of the word “OS” and the feature value “2” of the word “server” are stored as the filters representing features of the teacher data.

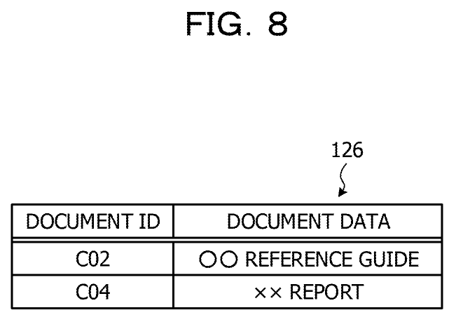

Returning to the description referring to FIG. 1, the pre-learning document data storage section 126 stores the document data used in pre-learning as a result of filtering, among all of the document data for pre-learning, that is, candidate document data. FIG. 8 illustrates an example of the pre-learning document data storage section. As illustrated in FIG. 8, the pre-learning document data storage section 126 has items including “document ID” and “document data”. For example, the pre-learning document data storage section 126 stores one record for each document ID.

The “document ID” is an identifier that identifies document data for pre-learning. The “document data” indicates the document data for pre-learning. That is, the “document data” is an example of a corpus for unsupervised learning. In the example illustrated in FIG. 8, as in FIG. 3, for convenience of description, the “document data” is document name. In the example illustrated in FIG. 8, among the document data in FIG. 3, document data having the document IDs “C02” and “C04” are stored as document data for pre-learning. As in FIG. 3, the “document data” includes each sentence constituting the document, that is, a plurality of sentences.

Returning to the description referring to FIG. 1, the pre-learnt model storage section 127 stores a pre-learnt model generated by machine learning using the document data for pre-learning. That is, the pre-learnt model storage section 127 stores the pre-learnt model acquired by machine learning of the document data for pre-learning.

The learnt model storage section 128 stores a learnt model generated by machine learning using the pre-learnt model and the teacher data. That is, the learnt model storage section 128 stores the learnt model acquired by machine learning of the teacher data for actual learning.

For example, the control unit 130 is embodied by causing a central processing unit (CPU) or a micro processing unit (MPU) to run a program stored in an internal storage device in a RAM as a working area. The control unit 130 may be embodied as an integrated circuit such as an application specific integrated circuit (ASIC) or a field programmable gate array (FPGA). The control unit 130 has acceptance section 131, a generation section 132, an identification section 133, and a learning section 134, and achieves or performs below-mentioned information processing functions and actions. The internal configuration of the control unit 130 is not limited to the configuration illustrated in FIG. 1, and may be any other configuration as long as it may execute below-mentioned information processing.

The acceptance section 131 receives and accepts a plurality of document data and teacher data from another information processor not illustrated via the communication unit 110. That is, the acceptance section 131 accepts the teacher data used in supervised learning, and the plurality of document data each including a plurality of sentences. The acceptance section 131 assigns the document ID to each of the accepted document data, and stores them in the document data storage section 121. The acceptance section 131 also assigns the teacher document ID to the accepted teacher data, and stores them in the teacher data storage section 122. The teacher data may be a plurality of teacher data. When storing the plurality of document data in the document data storage section 121, and storing the teacher data in the teacher data storage section 122, the acceptance section 131 outputs a filter generation instruction to the generation section 132.

When receiving the filter generation instruction from the acceptance section 131, the generation section 132 executes filter generation processing, and generates a filter. The generation section 132 refers to the document data storage section 121, extracts words in all of the document data for pre-learning, for example, by morphological analysis, and calculates the number of appearances of each word. When calculating the number of appearances of each word, the generation section 132 calculates the first feature value by normalizing the frequency of appearance based on the number of appearances. The generation section 132 associates the calculated first feature value with the number of appearances, and stores them in the first feature value storage section 123. The first feature value may be found, for example, by using an equation: first feature value=(x−μ)/σ. Here, x denotes the number of appearances (frequency), μ denotes the average of the number of appearances, and σ denotes variance.

Referring to the teacher data storage section 122, the generation section 132 extracts words in the teacher data, for example, by morphological analysis, and calculates the number of appearances of each of the extracted words. When calculating the number of appearances of each word, the generation section 132 calculates the second feature value by normalizing the frequency of appearance of each word based on the number of appearances. The generation section 132 associates the calculated second feature value with the word and the number of appearances, and stores them in the second feature value storage section 124. The second feature value may be also found in the same manner as the first feature value.

The generation section 132 extracts the word to be used as a filter, based on the first feature value and the second feature value. For example, the generation section 132 extracts the word having the first feature value of “0.5” or less and the second feature value of “1” or more, as the word to be used as the filter. The generation section 132 stores the extracted word and its second feature value, that is, the filter, in the filter storage section 125. When storing the filter in the filter storage section 125, the generation section 132 outputs an identification instruction to the identification section 133.

When receiving the identification instruction from the generation section 132, the identification section 133 executes identification processing, sorts the document data for pre-learning, and identifies document data used in pre-learning. The identification section 133 refers to the document data storage section 121 to select one candidate document data for pre-learning. The identification section 133 extracts words in the selected document data, and calculates the number of appearances of each of the extracted words. When calculating the number of appearances of each word, the identification section 133 calculates a third feature value by normalizing the frequency of appearance based on the number of appearances of each word in the selected document data.

When calculating the third feature value, the identification section 133 refers to the filter storage section 125, and based on the calculated third feature value and the filter, extracts the third feature value of the word to be compared with the filter in similarity. The identification section 133 calculates the similarity between the third feature value of the extracted word and the second feature value. The identification section 133 may use cos similarity or Euclidean distance as the similarity between the third feature value and the second feature value.

The identification section 133 determines whether or not the calculated similarity is equal to or greater than a threshold. The threshold may be set to any value. When determining that the similarity is equal to or greater than the threshold, the identification section 133 adopts the selected document data as document data for pre-learning, and stores the selected document data in the pre-learning document data storage section 126. When determining that the similarity is smaller than the threshold, the identification section 133 decides that the selected document data is not adopted as document data for pre-learning.

When the processing of determining the similarity of the selected document data is finished, the identification section 133 refers to the document data storage section 121, and determines whether or not candidate document data that has not been determined in terms of similarity is present. When determining that candidate document data that has not been determined in terms of similarity is present, the identification section 133 selects one candidate document data for next pre-learning, and makes determination in terms of similarity, that is, determines whether or not the one candidate document data is adopted as document data for pre-learning. When determining that candidate document data that has not been determined in terms of similarity is not present, the identification section 133 outputs a pre-learning instruction to the learning section 134, and finishes the identification processing.

In other words, the identification section 133 identifies any one of the plurality of document data, based on the degree of correlation between the accepted teacher data and each of the accepted document data. For example, the identification section 133 identifies any one document data based on the similarity between the frequency of appearance of words in the teacher data and the frequency of appearance of words in each of the plurality of document data. For example, the identification section 133 extracts the feature value of the word used for determining the similarity, based on the feature value of the frequency of appearance of the word in the teacher data and the feature value of the frequency of appearance of the word in each of the plurality of document data. The identification section 133 identifies any one of the plurality of document data, based on the feature value of the extracted word. For example, the identification section 133 identifies any one of the plurality of document data, based on the similarity between the feature value of the extracted word, and the feature value of the frequency of appearance of the word in each of the plurality of document data, which corresponds to the feature value of the extracted word.

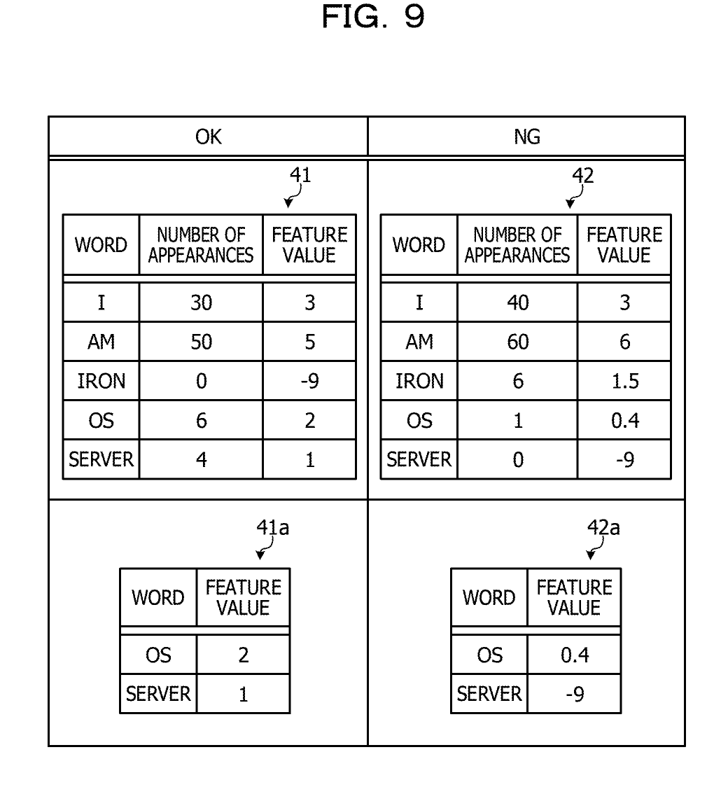

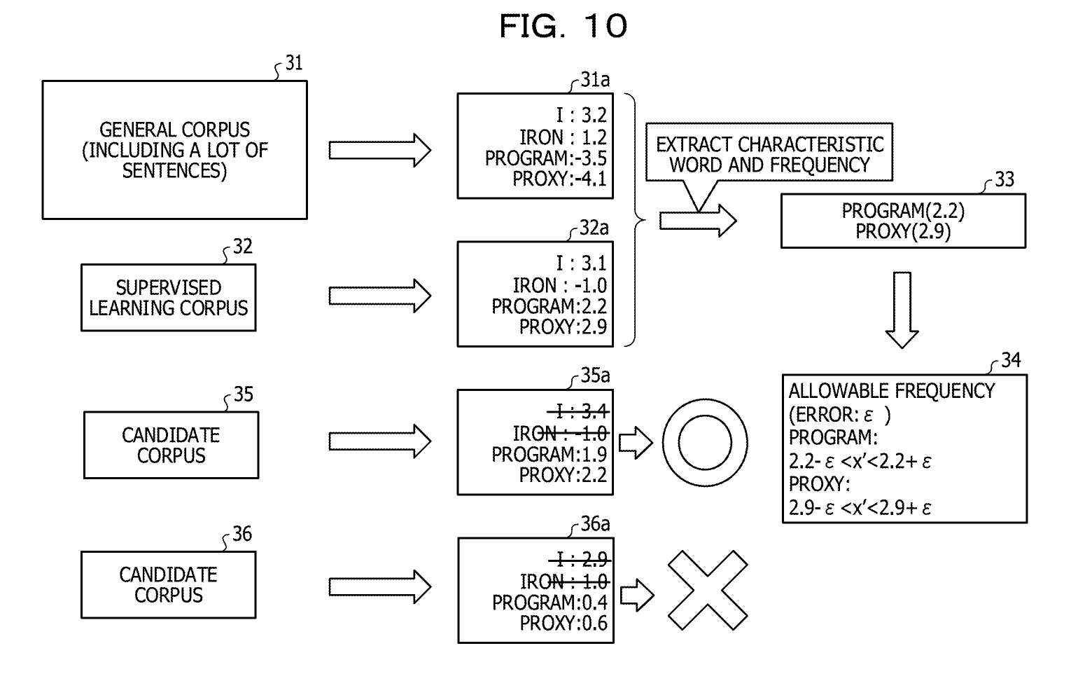

Referring to FIGS. 9 and 10, filtering will be described below. FIG. 9 illustrates an example of a result of filtering. In a table 41 illustrated in FIG. 9, third feature values in selected document data are associated with respective words and the number of appearances. The table 41a represents the third feature values of extracted words to be compared with the filter in terms of similarity, when the filter in the filter storage section 125 is used. The table 41a includes the third feature value “2” of the word “OS” and the third feature value “1” of the word “server”. Here, when the cos similarity is used as the similarity, the cos similarity between the table 41a and the filter is expressed by a following equation (1). A threshold of the similarity used in filtering is set to, for example, “0.2”.

cos similarity ((1, 2), (2, 1))=(2+2)/(√5×√5)=0.8 (1)

In the case of the table 41a, since the cos similarity is “0.8” according to the equation (1) and is greater than the threshold of “0.2”, the document data in table 41 is adopted for pre-learning.

In a table 42, third feature values in selected document data that is different from the document data in table 41 are associated with respective words and the number of appearances. The table 42a represents the third feature values of extracted words to be compared with the filter in terms of similarity, when the filter in the filter storage section 125 is used. The table 42a includes the third feature value “0.4” of the word “OS” and the third feature value “−9” of the word “server”. When the cos similarity is found in the same manner as in table 41a, the cos similarity between the table 42a and the filter is expressed by a following equation (2).

cos similarity ((1, 2), (0.4, −9))=(0.4−18)/(√5×√81.16)=−0.9 (2)

In the case of the table 42a, since the cos similarity is “−0.9” according to the equation (2) and is smaller than the threshold of “0.2”, the document data in table 42 is not adopted for pre-learning.

FIG. 10 illustrates an example of filtering based on the frequency of appearance of words. In FIG. 10, the above description is more generalized, and an allowable frequency (feature value) in place of threshold is used to determine the similarity. As illustrated in FIG. 10, the generation section 132 calculates a feature value 31a of the normalized frequency of appearance of noun, verb, and so on in a general corpus 31. The general corpus 31 corresponds to the above-mentioned all document data for pre-learning, and the feature value 31a corresponds to the first feature value. Next, the generation section 132 calculates a feature value 32a of the normalized frequency of appearance of noun, verb, and so on in a supervised learning corpus 32. The supervised learning corpus 32 corresponds to the teacher data, and the feature value 32a corresponds to the second feature value.

The generation section 132 extracts characteristic word and frequency (feature value), based on the feature value 31a and the feature value 32a to generate a filter 33. That is, in the example illustrated in FIG. 10, the feature value “2.2” of the word “program” and the feature value “2.9” of the word “proxy” become the filter. The identification section 133 sets a range containing an error E as the similarity of the feature value, that is, an allowable frequency 34. The range containing the error E corresponds to the above threshold for determining the similarity. That is, the identification section 133 may use the range containing the error E in place of the threshold to determine the similarity. In the example illustrated in FIG. 10, given that the frequency of a determination target (feature value) is x′, the allowable frequency 34 may be expressed as “2.2−ε<x′<2.2+ε” in the word “program”, and “2.9−ε<x′<2.9+ε” in the word “proxy”.

The identification section 133 calculates feature values 35a, 36a for candidate corpuses 35, 36. That is, the candidate corpuses 35, 36 correspond to the above-mentioned candidate document data, and the feature values 35a, 36a correspond to the above-mentioned third feature value. The identification section 133 compares the frequency (feature value) of the word extracted using the filter 33 among the feature values 35a, 36a with the allowable frequency 34. At this time, given that E is set to “1”, the allowable frequency 34 becomes “1.2<x′<3.2” in the word “program” and “1.9<x′<3.9” in the word “proxy”. The frequency (feature value) of the word “program” is “1.9”, and the frequency (feature value) of the word “proxy” is “2.2” in the feature value 35a, and falls within the range of the allowable frequency 34. On the contrary, the frequency (feature value) of the word “program” is “0.4”, and the frequency (feature value) of the word “proxy” is “0.6” in the feature value 36a, and falls without the range of the allowable frequency 34. Thus, the identification section 133 uses the candidate corpus 35 in pre-learning, and does not use the candidate corpus 36 in pre-learning. It is noted that a predetermined ratio of a plurality of words in a candidate corpus falls within the range of the allowable frequency 34, the candidate corpus may be used in pre-learning. The predetermined ratio may be set to 50%, for example.

Returning to the description referring to FIG. 1, when receiving the pre-learning instruction from the identification section 133, the learning section 134 performs pre-learning. Referring to the pre-learning document data storage section 126, the learning section 134 performs machine learning using the document data for pre-learning to generate a pre-learnt model. The learning section 134 stores the generated pre-learnt model in the pre-learnt model storage section 127. That is, the learning section 134 machine-learns characteristic information on any one identified document data. The characteristic information is information indicating meaning of words (parts of speech) and relationship between words (dependency) in sentences in the document data for pre-learning.

When generating the pre-learnt model, the learning section 134 refers to the teacher data storage section 122, and performs machine learning using the generated pre-learnt model and the teacher data to generate a learnt model. The learning section 134 stores the generated learnt model in the learnt model storage section 128.

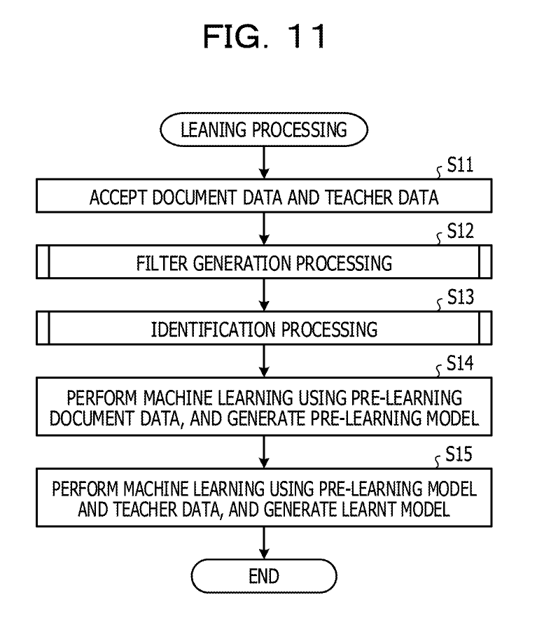

Next, operations of the learning apparatus 100 in this embodiment will be described. FIG. 11 is a flow chart illustrating an example of learning processing in accordance with the embodiment.

The acceptance section 131 receives and accepts a plurality of document data and teacher data from another information processor not illustrated (Step S11). The acceptance section 131 assigns a document ID to each of the accepted document data, and stores them in the document data storage section 121. Further, the acceptance section 131 assigns a teacher document ID to the accepted teacher data, and stores them in the teacher data storage section 122. The acceptance section 131 outputs a filter generation instruction to the generation section 132.

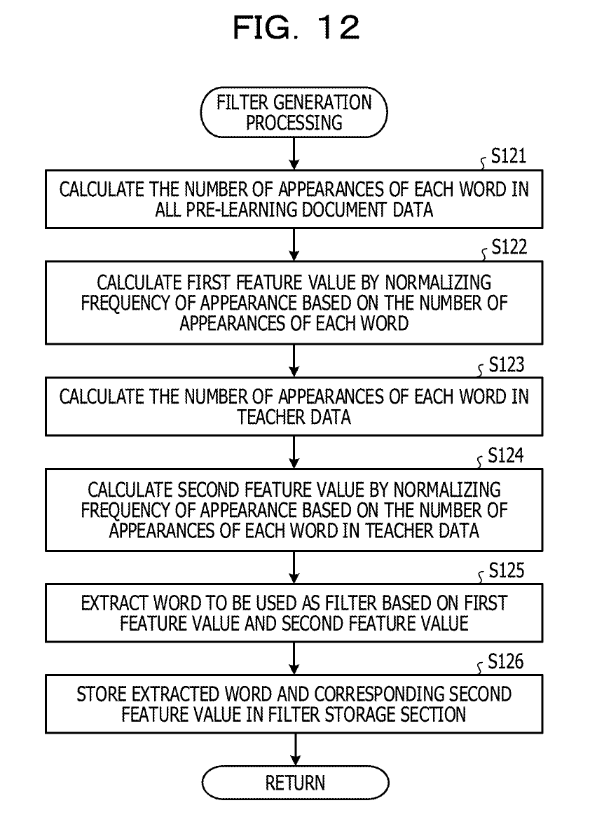

When receiving the filter generation instruction from the acceptance section 131, the generation section 132 executes filter generation processing (Step S12). The filter generation processing will be described with reference to FIG. 12. FIG. 12 is a flow chart illustrating an example of the filter generation processing.

Referring to the document data storage section 121, the generation section 132 calculates the number of appearances of each word in all document data for pre-learning (Step S121). When calculating the number of appearances of each word, the generation section 132 calculates the first feature value of each word by normalizing the frequency of appearance based on the number of appearances (Step S122). The generation section 132 associates the calculated first feature value with the word and the number of appearances, and stores them in the first feature value storage section 123.

Referring to the teacher data storage section 122, the generation section 132 calculates the number of appearances of each word in the teacher data (Step S123). The generation section 132 calculates the second feature value by normalizing the frequency of appearance based on the number of appearances of each word in the teacher data (Step S124). The generation section 132 associates the calculated second feature value with the word and the number of appearances, and stores them in the second feature value storage section 124.

The generation section 132 extracts the word used as the filter, based on the first feature value and the second feature value (Step S125). The generation section 132 stores the extracted word and the corresponding second feature value in the filter storage section 125 (Step S126). The generation section 132 outputs the identification instruction to the identification section 133, and finishes the filter generation processing to return to the initial processing.

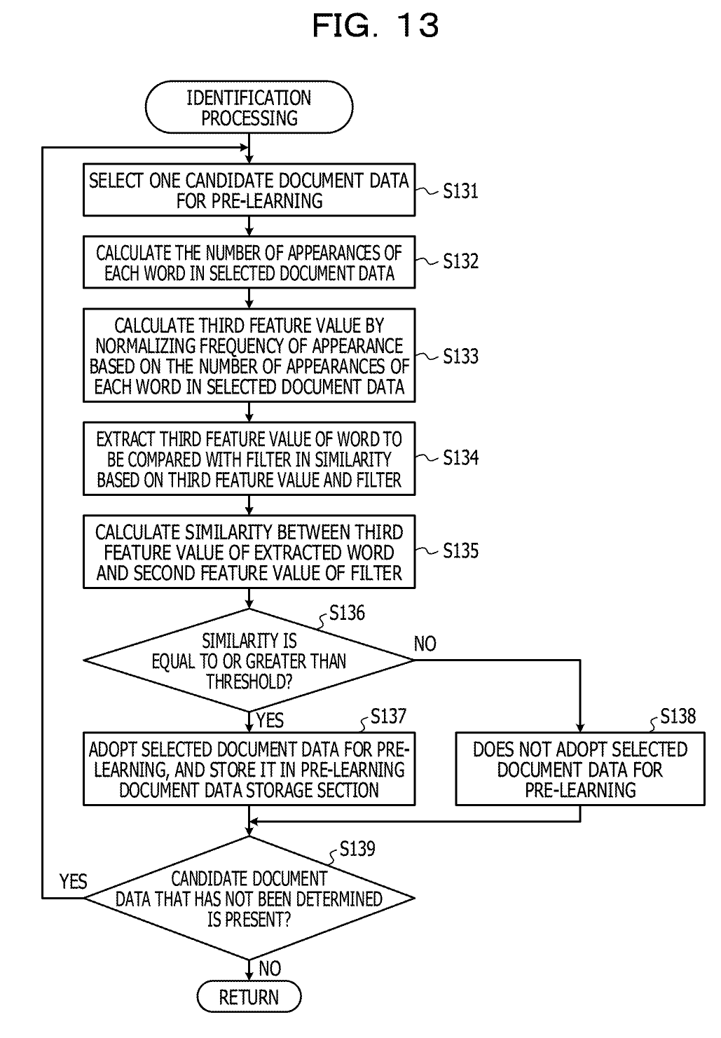

Returning to description referring to FIG. 11, when receiving the identification instruction from the generation section 132, the identification section 133 executes identification processing (Step S13). The identification processing will be described below with reference to FIG. 13. FIG. 13 is a flow chart illustrating an example of the identification processing.

Referring to the document data storage section 121, the identification section 133 selects one candidate document data for pre-learning (Step S131). The identification section 133 calculates the number of appearances of each word in the selected document data (Step S132). The identification section 133 calculates the third feature value by normalizing the frequency of appearance based on the number of appearances of each word in the selected document data (Step S133).

Referring to the filter storage section 125, the identification section 133 extracts the third feature value of the word to be compared with the filter in terms of similarity, based on the calculated third feature value and the filter (Step S134). The identification section 133 calculates the similarity between the third feature value of the extracted word and the second feature value of the filter (Step S135).

The identification section 133 determines whether or not the calculated similarity is equal to or greater than a threshold (Step S136). When determining that the similarity is equal to or greater than the threshold (Step S136: Yes), the identification section 133 adopts the selected document data for pre-learning, stores the selected document data in the pre-learning document data storage section 126 (Step S137), and proceeds to Step S139. When determining that the similarity is smaller than the threshold (Step S136: No), the identification section 133 decides that the selected document data is not adopted for pre-learning (Step S138), and proceeds to Step S139.

The identification section 133 determines whether or not candidate document data that has not been determined in terms of similarity is present (Step S139). When determining that the candidate document data that has not been determined in terms of similarity is present (Step S139: Yes), the identification section 133 returns to Step S131. When determining that the candidate document data that has not been determined in terms of similarity is not present (Step S139: No), the identification section 133 outputs the re-learning instruction to the learning section 134, finishes the identification processing, and returns to the initial processing.

Returning to the description referring to FIG. 11, when receiving the pre-learning instruction from the identification section 133, referring to the pre-learning document data storage section 126, the learning section 134 performs machine learning using the document data for pre-learning to generate a pre-learnt model (Step S14). The learning section 134 stores the generated pre-learnt model in the pre-learnt model storage section 127. Referring to the teacher data storage section 122, the learning section 134 performs machine learning using the generated pre-learnt model and the teacher data to generate a learnt model (Step S15). The learning section 134 stores the generated learnt model in the learnt model storage section 128, and finishes the learning processing. Thereby, the learning apparatus 100 may improve the learning efficiency. In addition, the learning apparatus 100 may acquire a better learning result as compared to the case of using only data for actual learning, that is, using only teacher data.

In this manner, the learning apparatus 100 performs unsupervised learning that is pre-learning for supervised learning. That is, the learning apparatus 100 accepts the teacher data used in supervised learning, and a plurality of document data each including a plurality of sentences. Further, the learning apparatus 100 identifies any one of the plurality of document data, based on the degree of correlation between the accepted teacher data and each of the accepted document data. Further, the learning apparatus 100 machine-learns characteristic information on the identified document data. Consequently, the learning apparatus 100 may improve the learning efficiency.

Further, the learning apparatus 100 identifies any one document data, based on the similarity between the frequency of appearance of the word in the teacher data and the frequency of appearance of the word in each of the plurality of document data. Consequently, the learning apparatus 100 performs pre-learning using the document data that is close to the teacher data, thereby improving the learning efficiency.

In addition, the learning apparatus 100 extracts the feature value of the word used for determining the similarity, based on the feature value of the frequency of appearance of the word in the teacher data and the feature value of the frequency of appearance of the word in each of the plurality of document data. Further, the learning apparatus 100 identifies any one of the plurality of document data, based on the feature value of the extracted word. Consequently, the learning apparatus 100 may further improve the learning efficiency.

In addition, the learning apparatus 100 identifies any one of the plurality of document data, based on the similarity between the feature value of the extracted word and the feature value of the frequency of appearance of the word in each of the plurality of document data, which corresponds to the feature value of the extracted word. Consequently, the learning apparatus 100 may further improve the learning efficiency.

In the above-mentioned embodiment, the similarity based on the frequency of appearance of word is used as the degree of correlation between the teacher data and each of the plurality of document data, the degree of correlation is not limited to such similarity. For example, the similarity between the teacher data and each of the plurality of document data may be determined by vectorizing documents themselves. For example, documents may be vectorized by using Doc2Vec.

Each component in the illustrated sections do not have to be physically configured as illustrated. That is, the sections is not limited to distribution or integration as illustrated, and whole or a part of the sections may be physically or functionally distributed or integrated in any suitable manner depending on loads and usage situations. For example, the generation section 132 may be integrated with the identification section 133. Further, the illustrated processing is not limited to the above-mentioned order, and may be simultaneously executed or reordered so as not to cause any contradiction.

Various processing functions performed by the devices may be wholly or partially performed on a CPU (or a microcomputer such as MPU or micro controller unit (MCU)). As a matter of course, the various processing functions may be wholly or partially performed on a program analyzed and executed on a CPU (or a microcomputer such as MPU or MCU), or hardware by wired-logic.

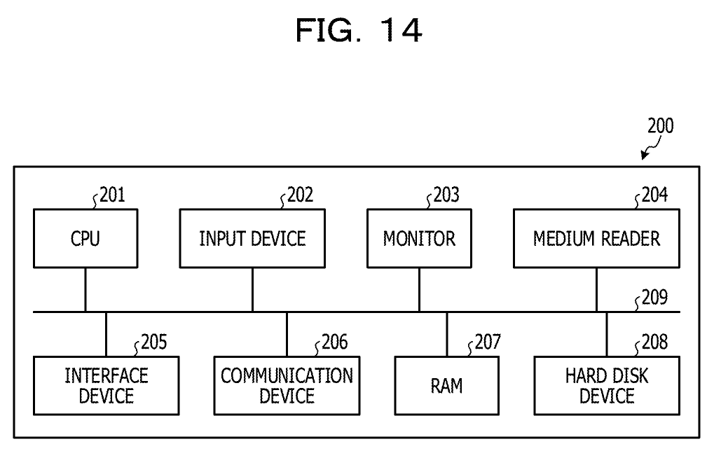

The various processing described in above embodiment may be achieved by causing a computer to run a prepared program. An example of the computer that runs a program having the same functions as the above embodiment will be described below. FIG. 14 illustrates an example of the computer that runs the learning program.

As illustrated in FIG. 14, a computer 200 has a CPU 201 that executes various calculations, an input device 202 that accepts data, and a monitor 203. The computer 200 further has a medium reader 204 that reads a program and so on from a storage medium, an interface device 205 for connection to various devices, and a communication device 206 for wired or wireless communication with other information processors. The computer 200 further has a RAM 207 that temporarily stores various information, and a hard disc device 208. The devices 201 to 208 are connected to a bus 209.

The hard disc device 208 stores the learning program having the same functions as the acceptance section 131, the generation section 132, the identification section 133, and the learning section 134 as illustrated in FIG. 1. The hard disc device 208 stores the document data storage section 121, the teacher data storage section 122, the first feature value storage section 123, and the second feature value storage section 124. The hard disc device 208 further stores the filter storage section 125, the pre-learning document data storage section 126, the pre-learnt model storage section 127, the learnt model storage section 128, and various data for executing the learning program. The input device 202 accepts various information such as operational information, for example, from the administrator of the computer 200. The monitor 203 displays various screens such as a display screen to the administrator of the computer 200. The interface device 205 is connected to, for example, a printer. For example, the communication device 206 has the same function as the communication unit 110 illustrated in FIG. 1, and is connected to a network not illustrated to exchange various information with other information processors.

The CPU 201 reads each program stored in the hard disc device 208, and expands and executes the programs in the RAM 207, thereby performing various processing. These programs may cause the computer 200 to function as the acceptance section 131, the generation section 132, the identification section 133, and the learning section 134 as illustrated in FIG. 1.

It is noted that the learning program is not necessarily stored in the hard disc device 208. For example, the computer 200 may read and execute a program stored in a computer-readable storage medium. Examples of the storage medium that may be read by the computer 200 include portable storage media such as CD-ROM, DVD disc, and Universal Serial Bus (USB) memory, semiconductor memories such as flash memory, and hard disc drive. Alternatively, the learning program may be stored in a device connected to public network, Internet, LAN, or the like, and the computer 200 may read the learning program from the device and execute the learning program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A machine learning method executed by a computer, the method comprising:
acquiring teacher data to be used in supervised learning, and plurality of document data;
specifying first document data among the plurality of document data in accordance with a first feature value and a second feature value, the first feature value being decided in accordance with a frequency of appearance of a word in the teacher data, the second feature value being decided in accordance with a frequency of appearance of the word in each of the plurality of document data; and
performing machine-learning of characteristic information of the first document data as pre-learning for the supervised learning.

2. The machine learning method according to claim 1, wherein a similarity between the second feature value and the first feature value is no less than a threshold.

3. The machine learning method according to claim 1, further comprising, prior to the specifying: selecting the word in accordance with a first plurality of feature values and a plurality of second feature values, the first plurality of feature values being decided in accordance with frequencies of appearance of a plurality of words in the teacher data, the plurality of words including the word, the second plurality of feature values being decided in accordance with frequencies of appearance of the plurality of words in the plurality of document data.

4. The machine learning method according to claim 3, wherein the selecting the word is selecting the word having the first feature value that is no less than a first threshold among the plurality of first feature values.

5. The machine learning method according to claim 3, wherein a feature value corresponding to the word among the plurality of second feature values is no more than a second threshold.

6. The machine learning method according to claim 1, wherein among the plurality of document data, document data having the second feature value whose similarity with the first feature value is no more than a threshold is not used in the machine learning.

7. A machine learning apparatus comprising:
a memory; and
a processor coupled to the memory and the processor configured to:
acquire teacher data to be used in supervised learning, and plurality of document data,
perform a determine of first document data among the plurality of document data in accordance with a first feature value and a second feature value, the first feature value being decided in accordance with a frequency of appearance of a word in the teacher data, the second feature value being decided in accordance with a frequency of appearance of the word in each of the plurality of document data, and
perform machine-learning of characteristic information of the first document data as pre-learning for the supervised learning.

8. The machine learning apparatus according to claim 7, wherein a similarity between the second feature value and the first feature value is no less than a threshold.

9. The machine learning apparatus according to claim 7, the processor further configured to, prior to the determine: perform a selection of the word in accordance with a first plurality of feature values and a plurality of second feature values, the first plurality of feature values being decided in accordance with frequencies of appearance of a plurality of words in the teacher data, the plurality of words including the word, the second plurality of feature values being decided in accordance with frequencies of appearance of the plurality of words in the plurality of document data.

10. The machine learning apparatus according to claim 9, wherein the selection of the word is selecting the word having the first feature value that is no less than a first threshold among the plurality of first feature values.

11. The machine learning apparatus according to claim 9, wherein a feature value corresponding to the word among the plurality of second feature values is no more than a second threshold.

12. The machine learning apparatus according to claim 7, wherein among the plurality of document data, document data having the second feature value whose similarity with the first feature value is no more than a threshold is not used in the machine learning.

13. A non-transitory computer-readable medium storing a machine learning program that causes a computer to execute a process comprising:
acquiring teacher data to be used in supervised learning, and plurality of document data;
specifying first document data among the plurality of document data in accordance with a first feature value and a second feature value, the first feature value being decided in accordance with a frequency of appearance of a word in the teacher data, the second feature value being decided in accordance with a frequency of appearance of the word in each of the plurality of document data; and
performing machine-learning of characteristic information of the first document data as pre-learning for the supervised learning.
